(19) United States
(12) Patent Application Publication
(10) Pub. No.: US 2018/0010600 A1
(43) Pub. Date: Jan. 11, 2018

(54) HIGH-PRESSURE FUEL PUMP

(71) Applicant: Delphi Technologies, Inc., Troy, MI (US)

(72) Inventor: Joseph G. Spakowski, Rochester, NY (US)

(21) Appl. No.: 15/205,349

(22) Filed: Jul. 8, 2016

(51) Int. Cl. F04B 53/14; F02M 59/02; F04B 19/22; F04B 53/16

(52) U.S. Cl. CPC F04B 53/143; F04B 53/16; F02M 59/025; F04B 19/22

(57) ABSTRACT

A high-pressure fuel pump includes a pump housing which defines a pumping chamber, a fuel inlet which allows low-pressure fuel into the pumping chamber, a fuel outlet which allows high-pressure fuel out of the pumping chamber, and a plunger bore which extends along an axis and opens into the pumping chamber. The high-pressure fuel pump also includes a pumping plunger which reciprocates within the plunger bore along the axis such that reciprocation of the pumping plunger within the plunger bore increase and decreases a volume of the pumping chamber. The pumping plunger includes a sealing ring groove which is concentric with the plunger bore, the sealing ring groove including a sealing ring therein which engages the plunger bore in an interference fit. A diametric clearance greater than 12 microns is provided between the pumping plunger and the plunger bore.

### TECHNICAL FIELD OF INVENTION

The present invention relates to a fuel pump, more particularly to a high-pressure fuel pump which provides fuel at high-pressure for injection directly into a combustion chamber of an internal combustion engine, even more particularly to such a fuel pump having a pumping plunger which reciprocates within a plunger bore of a pump housing to pressurize fuel within a pumping chamber defined in the pump housing, and still even more particularly to such a fuel pump in which the pumping plunger includes an annular sealing ring groove and a sealing ring within the sealing ring groove which engages the plunger bore in an interference fit to prevent fuel from escaping the pumping chamber between the interface of the pumping plunger and the plunger bore.

### BACKGROUND OF INVENTION

Fuel systems for modern internal combustion engines typically employ either 1) port fuel injection (PFI) where fuel is injected into an air intake manifold of the internal combustion engine at relatively low pressure (typically below about 500 kPa) and subsequently passed to the combustion chamber of the internal combustion engine or 2) gasoline direct injection (GDi) where fuel is injected directly into the combustion chamber of the internal combustion engine at relatively high pressure (typically above about 14 MPa). In PFI systems, the fuel is typically pumped from a fuel tank to the internal combustion engine by an electric fuel pump which is located with the fuel tank of the fuel system. However, GDi systems require an additional fuel pump to boost the pressure of the fuel compared to the pressure which can be achieved by the electric fuel pump. In order to elevate the fuel pressure to the magnitude needed for direct injection, it is typical to employ a piston-type high-pressure fuel pump which is driven by a camshaft of the internal combustion engine.

In a typical high-pressure fuel pump, a pump housing defines an inlet, an outlet, a pumping chamber, and a plunger bore which opens into the pumping chamber. A pumping plunger is reciprocated within the plunger bore by a camshaft of the internal combustion engine such that each cycle of the pumping plunger increases and decreases the volume of the pumping chamber. An inlet valve selectively opens when the pumping plunger is moving in a direction which increases the volume of the pumping chamber, i.e. the inlet stroke, thereby allowing low-pressure fuel to enter the pumping chamber. When the pumping plunger is moving in a direction which decreases the volume of the pumping chamber, i.e. the pressure stroke, fuel within the pumping chamber is elevated in pressure as a result of the decreased volume. When the pressure of the fuel within the pumping chamber reaches a predetermined threshold, an outlet valve opens, thereby allowing high-pressure fuel to be discharged from the outlet. An example of such a high-pressure fuel pump is disclosed in U.S. Pat. No. 8,573,112 to Nakayama et al. which is hereinafter referred to as Nakayama et al. and which is incorporated herein by reference in its entirety.

In order to allow for efficient operation of a high-pressure fuel pump as described above, it is necessary to minimize leakage between the pumping plunger and the plunger bore. Minimization of leakage between the pumping plunger and the plunger bore is typically dealt with by providing a close clearance between the pumping plunger and the plunger bore. In order to keep leakage at an acceptable level, the clearance is less than 12 microns. However, it is important that the clearance between the pumping plunger and the plunger bore not be too small because there is a risk that the pumping plunger could seize within the plunger bore during operation due to heat generated by operation of the high-pressure pump causing the pumping plunger to expand radially outward to a greater extent than the plunger bore expands, due to poor lubrication as a result of insufficient clearance for fuel between the pumping plunger and the plunger bore, and due to side load effects on the pumping plunger. As a result, a clearance of 11 microns plus or minus 1 micron may be a typical acceptable tolerance in the manufacture of the pumping plunger and the plunger bore. Such a tolerance is costly to implement and may require match honing between the pumping plunger and the plunger bore, thereby adding time and complexity to the manufacturing process. Furthermore, such a tolerance may require that the pump be increased in fuel pumping capacity to accommodate the low efficiency that is experienced, particularly at low-speed operation of the internal combustion engine.

What is needed is a high-pressure fuel pump which minimizes or eliminates one or more of the shortcomings as set forth above.

### SUMMARY OF THE INVENTION

Briefly described, a high-pressure fuel pump includes a pump housing which defines a pumping chamber, a fuel inlet which allows low-pressure fuel into the pumping chamber, a fuel outlet which allows high-pressure fuel out of the pumping chamber, and a plunger bore which extends along an axis and opens into the pumping chamber. The high-pressure fuel pump also includes a pumping plunger which reciprocates within the plunger bore along the axis such that reciprocation of the pumping plunger within the plunger bore increase and decreases a volume of the pumping chamber. Low-pressure fuel flows from the fuel inlet to the pumping chamber when the volume increases and high-pressure fuel is discharged from the pumping chamber through the fuel outlet when the volume decreases. The pumping plunger includes a sealing ring groove which is concentric with the plunger bore and the sealing ring groove includes a sealing ring therein which engages the plunger bore in an interference fit. A diametric clearance greater than 12 microns is provided between the pumping plunger and the plunger bore.

Further features and advantages of the invention will appear more clearly on a reading of the following detailed description of the preferred embodiment of the invention, which is given by way of non-limiting example only and with reference to the accompanying drawings.

### BRIEF DESCRIPTION OF DRAWINGS

This invention will be further described with reference to the accompanying drawings in which:

FIG. 1 is a schematic view of a fuel system including a high-pressure fuel pump in accordance with the present invention;

FIG. 2 is an enlarged view of a portion of FIG. 1 showing a portion of a pumping plunger within a respective plunger bore of a pump housing; and

FIG. 3 is the enlarged view of FIG. 2 showing a variation of the pumping plunger.

### DETAILED DESCRIPTION OF INVENTION

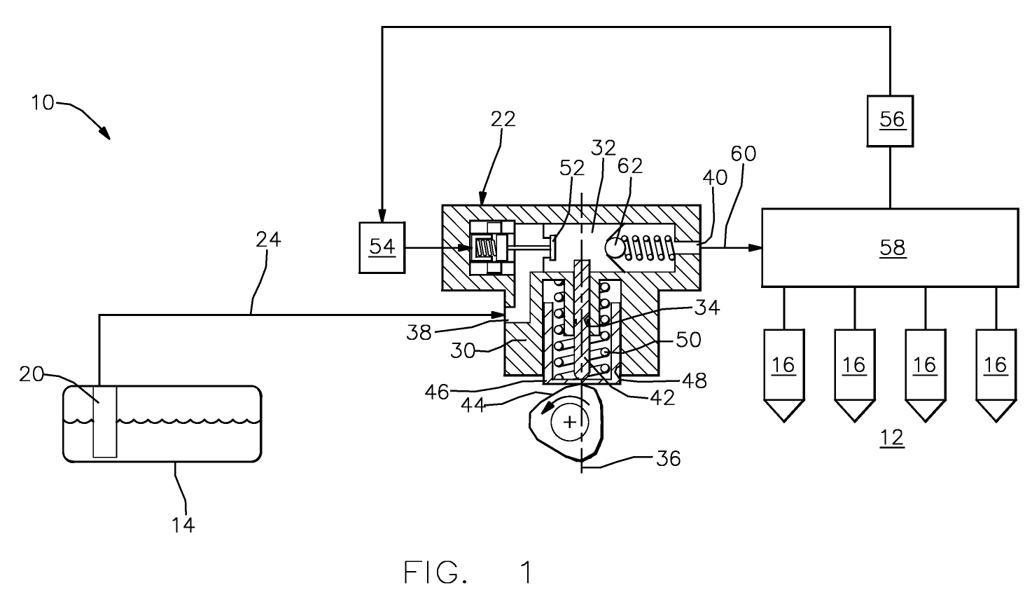

In accordance with a preferred embodiment of this invention and referring to FIG. 1, a fuel system 10 for an internal combustion engine 12 is shown. Fuel system 10 generally includes a fuel tank 14 which holds a volume of fuel to be supplied to internal combustion engine 12 for operation thereof; a plurality of high-pressure fuel injectors 16 which inject fuel directly into respective combustion chambers (not shown) of internal combustion engine 12; a low-pressure fuel pump 20; and a high-pressure fuel pump 22 where the low-pressure fuel pump 20 draws fuel from fuel tank 14 and elevates the pressure of the fuel for delivery to high-pressure fuel pump 22 where the high-pressure fuel pump 22 further elevates the pressure of the fuel for delivery to high-pressure fuel injectors 16. By way of non-limiting example only, low-pressure fuel pump 20 may elevate the pressure of the fuel to about 500 kPa or less and high-pressure fuel pump 22 may elevate the pressure of the fuel to above about 14 MPa where pressures on the order of 40 MPa and above are anticipated. While four high-pressure fuel injectors 16 have been illustrated, it should be understood that a lesser or greater number of high-pressure fuel injectors 16 may be provided. As shown, low-pressure fuel pump 20 may be provided within fuel tank 14, however low-pressure fuel pump 20 may alternatively be provided outside of fuel tank 14. Low-pressure fuel pump 20 may be an electric fuel pump. A low-pressure fuel supply passage 24 provides fluid communication from low-pressure fuel pump 20 to high-pressure fuel pump 22. High-pressure fuel pump 22 will be described in greater detail in the paragraphs that follow.

High-pressure fuel pump 22 includes a pump housing 30 which defines a pumping chamber 32 and a plunger bore 34 which opens into pumping chamber 32 such that plunger bore 34 extends along an axis 36. Pump housing 30 also includes a fuel inlet 38 in fluid communication with low-pressure fuel supply passage 24 such that fuel inlet 38 selectively allows low-pressure fuel from low-pressure fuel pump 20 to enter pumping chamber 32 as will be described in greater detail later. Pump housing 30 also defines a fuel outlet 40 which selectively allows high-pressure fuel to exit pumping chamber 32 as will be described in greater detail later. While pump housing 30 has been illustrated schematically as single-piece construction, it should be understood that pump housing 30 may comprise two or more pieces which are joined together to provide the features described herein.

High-pressure fuel pump 22 also includes a pumping plunger 42 located within plunger bore 34 such that pumping plunger 42 reciprocates within plunger bore 34 along axis 36. Pumping plunger 42 is reciprocated within plunger bore 34, by way of non-limiting example only, by a camshaft 44 of internal combustion engine 12. Pumping plunger 42 is attached to (in contact with) a cam follower 46 which follows the profile of camshaft 44. Cam follower 46 is axially guided within a cam follower bore 48 of pump housing 30 such that a return spring 50 is compressed axially between pump housing 30 and cam follower 46 to maintain cam follower 46 in contact with camshaft 44 as camshaft 44 rotates. While cam follower 46 has been embodied as being guided within cam follower bore 48 of pump housing 30, it should now be understood that cam follower 46 may alternatively be guided within a bore of internal combustion engine 12 that is not within pump housing 30. When camshaft 44, cam follower 46, and return spring 50 cause pumping plunger 42 to move downward as viewed in the figures, the volume of pumping chamber 32 is increased, thereby resulting in an inlet stroke. Conversely, when camshaft 44 and cam follower 46 cause pumping plunger 42 to move upward as viewed in the figures, the volume of pumping chamber 32 is decreased, thereby resulting in a pressure stroke. While not shown, it should be understood that a low-pressure seal may be provided to prevent fuel, that has leaked past the clearance between pumping plunger 42 and plunger bore 34, from mixing with oil that lubricates internal combustion engine 12. One arrangement of such a low-pressure seal is illustrated by Nakayama et al. which was previously referenced above.

High-pressure fuel pump 22 also includes an inlet valve 52 which selectively opens to permit fuel to enter pumping chamber 32 from low-pressure fuel supply passage 24. Inlet valve 52 may be, by way of non-limiting example only, a solenoid operated valve which is controlled by a controller 54. Controller 54 may receive input from a pressure sensor 56 which supplies a signal indicative of the pressure of the fuel being supplied to high-pressure fuel injectors 16. As illustrated, a pressure sensor 56 may arranged to read the fuel pressure within a high-pressure fuel rail 58 which receives high-pressure fuel from fuel outlet 40 through a high-pressure fuel supply passage 60 such that high-pressure fuel rail 58 distributes high-pressure fuel to each of high-pressure fuel injectors 16. However, it should be understood that pressure sensor 56 may be positioned at other locations that are indicative of the pressure of the fuel being supplied to high-pressure fuel injectors 16. Controller 54 sends signals to inlet valve 52 to open and close inlet valve 52 as necessary to achieve a desired fuel pressure at pressure sensor 56 as may be determined by current and anticipated engine operating demands. When inlet valve 52 is opened while pumping plunger 42 is moving to increase the volume of pumping chamber 32, i.e. when inlet valve 52 is moving downward as viewed in the figures, fuel from low-pressure fuel supply passage 24 is allowed to flow into pumping chamber 32 through fuel inlet 38.

High-pressure fuel pump 22 also includes an outlet valve 62 which selectively opens to permit fuel to exit pumping chamber 32 to high-pressure fuel supply passage 60. Outlet valve 62 may be a spring-biased valve which opens when the pressure differential between pumping chamber 32 and high-pressure fuel supply passage 60 is greater than a predetermined threshold. Consequently, when camshaft 44 and cam follower 46 cause pumping plunger 42 to decrease the volume of pumping chamber 32, the fuel within pumping chamber 32 is pressurized. Furthermore, when the pressure within pumping chamber 32 is sufficiently high, outlet valve 62 is urged open by the fuel pressure, thereby causing pressurized fuel to be supplied to high-pressure fuel injectors 16 through fuel outlet 40, high-pressure fuel supply passage 60, and high-pressure fuel rail 58.

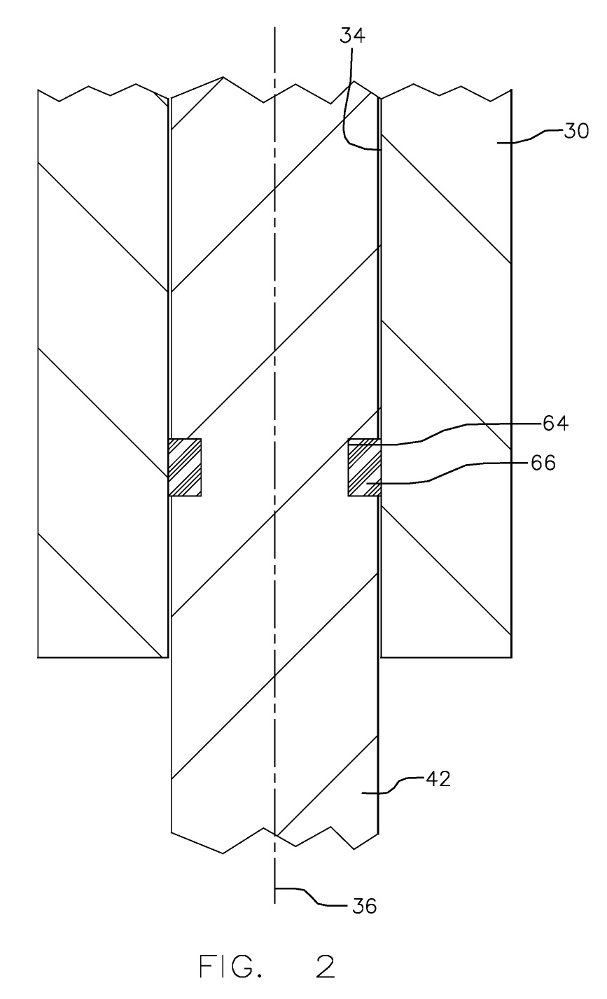

Reference will now be made to FIG. 2 which shows an enlarged portion of FIG. 1, more particularly, an enlarged portion showing portions of pump housing 30 and pumping plunger 42. In order to improve efficiency, particularly at low rotational speeds of camshaft 44 caused by low operating speeds of internal combustion engine 12, and to permit greater annular clearance between pumping plunger 42 and plunger bore 34, pumping plunger 42, which is cylindrical, is provided with a sealing ring groove 64 within which is located a sealing ring 66. Sealing ring groove 64 is annular in shape and concentric with pumping plunger 42 and plunger bore 34 such that sealing ring groove 64 extends radially inward from the outer periphery of pumping plunger 42. Sealing ring 66 is preferably made of PTFE (polytetrafluoroethylene) due to low friction and fuel resistant properties, however, other materials may be substituted. During installation, sealing ring 66 is elastically stretched over pumping plunger 42 and slid on the outer periphery of pumping plunger 42 until sealing ring 66 is aligned with sealing ring groove 64. After sealing ring 66 is aligned with sealing ring groove 64, sealing ring 66 retracts into sealing ring groove 64. Sealing ring 66 is sized to engage plunger bore 34 in an interference fit. Since sealing ring 66 engages plunger bore 34 in an interference fit, the diametric clearance between pumping plunger 42 and plunger bore 34 can be greater than 12 microns, thereby eliminating the need to match hone pumping plunger 42 and plunger bore 34. Preferably, the diametric clearance between pumping plunger 42 and plunger bore 34 is in the range of 13 microns to 30 microns. Furthermore, sealing ring 66 engaging plunger bore 34 in an interference fit increases the efficiency of high-pressure fuel pump 22, particularly at low rotational rates of camshaft 44, by minimizing fuel leakage between pumping plunger 42 and plunger bore 34. Sealing ring 66 is also sized such that when pumping plunger 42 with sealing ring 66 is installed within plunger bore 34, sealing ring 66 is held in radial compression between plunger bore 34 and pumping plunger 42. Furthermore, the radial compression of sealing ring 66 by plunger bore 34 and pumping plunger 42 causes sealing ring 66 to expand axially such that sealing ring 66 is held in axial compression between the upper and lower walls (as oriented in the figures) of sealing ring groove 64. Another added benefit of pumping plunger 42 including sealing ring 66 is that the risk of pumping plunger 42 seizing within plunger bore 34 is minimized because the clearance between pumping plunger 42 and plunger bore 34 can be increased to an extent such that thermal expansion of pumping plunger 42 in use will not be sufficient to bind pumping plunger 42 within plunger bore 34.

It is important to note that Nakayama et al., which was introduced above in the Background of Invention section, discloses a seal system, identified by reference number 21 in Nakayama et al., which maintains separation between gasoline and engine oil. However, the seal system of Nakayama et al., unlike sealing ring 66 of the present invention, does nothing to improve the efficiency of the fuel pump because the seal system of Nakayama et al. is on the low-pressure side of the interface of the pumping plunger and the plunger bore. Consequently, the efficiency of the fuel pump of Nakayama et al. is dependent upon the clearance between the pumping plunger and the plunger bore.

In operation, during the inlet stroke, inlet valve 52 is opened to allow fuel to flow into pumping chamber 32 from fuel inlet 38 as pumping plunger 42 is increasing the volume of pumping chamber 32 as a result of camshaft 44 and return spring 50. Inlet valve 52 may remain open during the inlet stroke for a period of time, determined by controller 54, which is sufficient to allow a volume of fuel into pumping chamber 32 that will satisfy the fueling needs of internal combustion engine 12. During the pressure stroke, when inlet valve 52 is closed, pumping plunger 42 decreases the volume of pumping chamber 32 as a result of camshaft 44. Decreasing the volume of pumping chamber 32 results in increasing the pressure of the fuel within pumping chamber 32 where the high-pressure fuel is contained within pumping chamber 32, in part, by the interference fit between sealing ring 66 and plunger bore 34. When the pressure within pumping chamber 32 is sufficiently high, outlet valve 62 is opened, thereby allowing high-pressure fuel to exit pumping chamber 32 through fuel outlet 40 and to be communicated to high-pressure fuel rail 58.

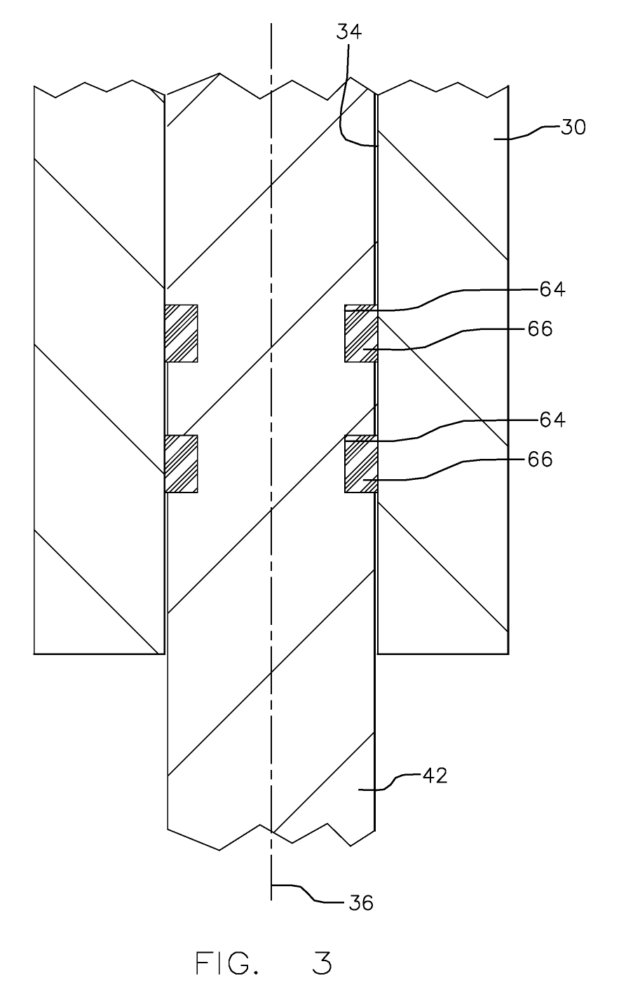

In a variation of FIGS. 1 and 2, FIG. 3 shows that pumping plunger 42 may include two sealing ring grooves 64 such that each sealing ring groove contains a respective sealing ring 66 which engages plunger bore 34 and pumping plunger 42 in the same manner described earlier with respect to FIG. 2. It should now be understood that additional sealing ring grooves 64 and sealing rings 66 may also be included.

As should now be readily apparent, the inclusion of sealing ring groove 64 and sealing ring 66 provides for greater efficiency of high-pressure fuel pump 22. In one test that was conducted on high-pressure fuel pumps that were otherwise the same, inclusion of sealing ring groove 64 and sealing ring 66 provided increased efficiency at all operational speeds of the high-pressure fuel pumps, with a particularly significant increase in efficiency at lower operating speeds. This increase in efficiency may allow for high-pressure fuel pump 22 to be downsized in fuel pumping capacity, thereby reducing the cost of high-pressure fuel pump 22, since high-pressure fuel pump 22 does not need to accommodate a loss in efficiency, particularly at low operational speeds of internal combustion engine 12. Downsizing the fuel pumping capacity of high-pressure fuel pump 22, for example by decreasing the diameter of pumping plunger 42, is important because emission regulation are continually being made more stringent and the desire to provide fuel at higher pressure is more desirable to better atomize the fuel which is beneficial for reducing emissions of internal combustion engine 12. Decreasing the diameter of pumping plunger 42 is a way to limit excessive loads on the valve train of internal combustion engine 12, but this can only be done if the efficiency of high-pressure fuel pump 22 is improved at higher pressures. A further benefit of sealing ring groove 64 and sealing ring 66 is that the clearance between pumping plunger 42 and plunger bore 34 is able to be increased, thereby eliminating the need for time consuming and costly manufacturing techniques such as match honing of pumping plunger 42 and plunger bore 34.

While this invention has been described in terms of preferred embodiments thereof, it is not intended to be so limited, but rather only to the extent set forth in the claims that follow.

We claim:

1. A high-pressure fuel pump comprising:
a pump housing which defines a pumping chamber, a fuel inlet which allows low-pressure fuel into said pumping chamber, a fuel outlet which allows high-pressure fuel out of said pumping chamber, and a plunger bore which extends along an axis and opens into said pumping chamber; and
a pumping plunger which reciprocates within said plunger bore along said axis such that reciprocation of said pumping plunger within said plunger bore increase and decreases a volume of said pumping chamber, low-pressure fuel flows from said fuel inlet to said pumping chamber when said volume increases, and high-pressure fuel is discharged from said pumping chamber through said fuel outlet when said volume decreases;
wherein said pumping plunger includes a sealing ring groove which is concentric with said plunger bore, said sealing ring groove including a sealing ring therein which engages said plunger bore in an interference fit; and
wherein a diametric clearance greater than 12 microns is provided between said pumping plunger and said plunger bore.

2. A high-pressure fuel pump as in claim 1 wherein said diametric clearance is in a range of 13 microns to 30 microns.

3. A high-pressure fuel pump as in claim 1 wherein said sealing ring is held in radial compression by said pumping plunger and said plunger bore.

4. A high-pressure fuel pump as in claim 2 wherein said sealing ring is held in axial compression within said sealing ring groove.

5. A high-pressure fuel pump as in claim 1 wherein said sealing ring is held in axial compression within said sealing ring groove.

6. A high-pressure fuel pump as in claim 1 wherein said pumping plunger also includes:
a second sealing ring groove which is concentric with said plunger bore, said second sealing ring groove including a second sealing ring therein which engages said plunger bore in an interference fit.

7. A high-pressure fuel pump as in claim 1 wherein said sealing ring groove is annular.

8. A high-pressure fuel pump as in claim 7 wherein said sealing ring is annular.
